(19) United States
(12) Patent Application Publication
(10) Pub. No.: US 2026/0023966 A1
(43) Pub. Date: Jan. 22, 2026

(54) APPARATUS AND METHOD FOR TRAINING AN EXCITATION MODEL USING REPRESENTATION DATA

(71) Applicant: Flourish Worldwide, LLC, Denver, CO (US)

(72) Inventor: Joseph J. Janiczek, Englewood, CO (US)

(73) Assignee: Flourish Worldwide, LLC, Denver, CO (US)

(21) Appl. No.: 18/778,094

(22) Filed: Jul. 19, 2024

(51) Int. Cl. G06N 3/08; G06N 3/045; G06N 3/0475

(52) U.S. Cl. CPC G06N 3/08; G06N 3/045; G06N 3/0475

(57) ABSTRACT

An apparatus and method training an excitation model using representation data which includes at least a processor and a memory communicatively connected to the at least a processor. The memory instructs the processor to instantiate a representation generator to generate a representation dataset, collect a first dataset from a system, wherein the representation dataset is transmitted to the system and a response is recorded from the system, train an excitation model on the first dataset, wherein the excitation model is configured to generate an excitation element, transmit the excitation element to the system, generate an error signal, modify the representation generator using the error signal, collect a second dataset from the system, retrain the excitation model using the second dataset, compare the first dataset to the second dataset to produce a convergent outcome of the system, and display convergent outcome using a display device.

### FIELD OF THE INVENTION

The present invention generally relates to the field of machine learning. In particular, the present invention is directed to an apparatus and a method for training an excitation model using representation data.

### BACKGROUND

Current systems for analyzing and comparing neurological function are limited by the complexities of the system and the multifaceted areas of function and assessment. There are various challenges of providing comprehensive targeted feedback for neurological function improvements.

### SUMMARY OF THE DISCLOSURE

In an aspect, an apparatus for training an excitation model using representation data includes at least a processor and a memory communicatively connected to the at least a processor. The memory contains instructions configuring the processor to, instantiate a representation generator, wherein the representation generator is configured to generate a representation dataset, wherein the representation dataset includes a plurality of evaluation metrics, collect a first dataset from a system, generate, using the representation generator and the first dataset, a first representation dataset, output an excitation element from an excitation model using first dataset, transmit the excitation element to the system, collect a second dataset from the system, generate an error signal as a function of the second dataset and the representation data, modify the representation generator using the error signal, wherein modifying representation generator is configured to generate at least a modified evaluation metric, output a second representation dataset using the modified representation generator, and output a second excitation element from the excitation model using the second representation dataset.

In another aspect, a method for training an excitation model using representation data includes instantiating a representation generator, wherein the representation generator is configured to generate a representation dataset, wherein the representation dataset includes a plurality of evaluation metrics, collecting a first dataset from a system, generating, using the representation generator and the first dataset, a first representation dataset, outputting an excitation element from an excitation model using first dataset, transmitting the excitation element to the system, collecting a second dataset from the system, generating an error signal as a function of the second dataset and the representation data, modifying the representation generator using the error signal, wherein modifying representation generator is configured to generate at least a modified evaluation metric, outputting a second representation dataset using the modified representation generator, and outputting a second excitation element from the excitation model using the second representation dataset.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus for training an excitation model using representation data;

FIG. 2 is a table illustrating exemplary domains;

FIG. 3 is an exemplary remote device including an exemplary graphical user interface of a remote device;

FIG. 4 is an exemplary remote device including an exemplary graphical user interface of a remote device illustrating moderate performance level of a subject on a given day;

FIG. 5 is an exemplary remote device including an exemplary graphical user interface of a remote device illustrating the focus tab of the dashboard screen of a user with an excellent performance level on a given day;

FIG. 6 is an exemplary remote device including an exemplary graphical user interface of a remote device illustrating the flywheel tab of the dashboard screen with exemplary domains;

FIG. 7 is an exemplary remote device including an exemplary graphical user interface of a remote device.

FIG. 8 is an exemplary remote device including an exemplary graphical user interface of a remote device.

FIG. 9 is a block diagram of an exemplary machine-learning process;

FIG. 10 is a diagram of an exemplary embodiment of a neural network;

FIG. 11 is a diagram of an exemplary embodiment of a node of a neural network;

FIG. 12 is a block diagram of an exemplary method for training an excitation model using representation data;

FIG. 13 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for training an excitation model using representation data. The apparatus includes at least a computing device comprised of a processor and a memory communicatively connected to the processor. The memory instructs the processor to instantiate a representation generator, wherein the representation generator is configured to generate a representation data, wherein the representation data includes a plurality of evaluation metrics. The processor then collects a first dataset from a system, wherein the representation data is transmitted to the system and a response is recorded from the system. Additionally, the processor trains an excitation model on the first dataset, wherein the excitation model is configured to generate an excitation element. The processor transmits the excitation element to the system using a graphical user interface. The memory then instructs the processor to generate an error signal as a function of the excitation element and the representation data. The processor modifies the representation generator using the error signal, wherein modifying representation generator is configured to generate at least a modified evaluation metric. The processor collects a second dataset from the system. Processor retrains the excitation model using the second dataset. The processor compares the first dataset to the second dataset to produce a convergent outcome of the system. The processor displays convergent outcome using a display device.

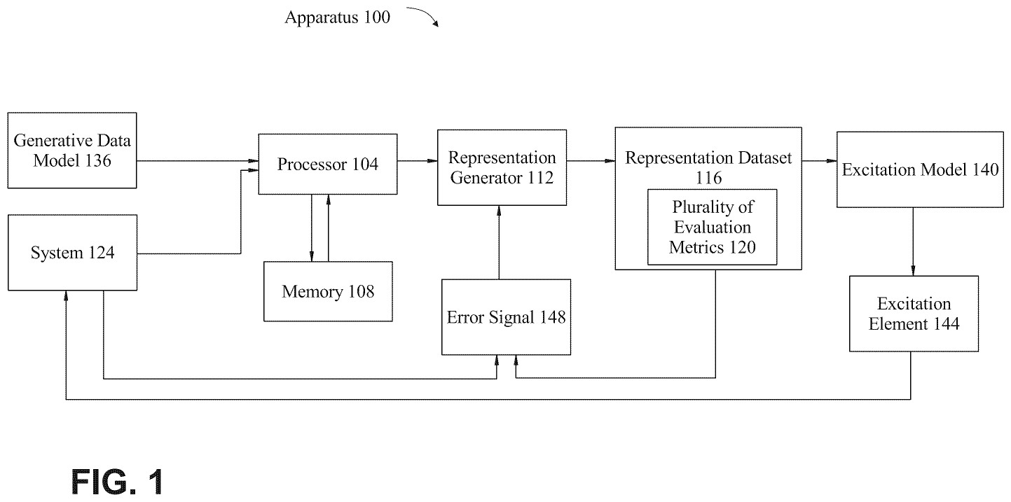

Referring now to FIG. 1, an exemplary embodiment of apparatus 100 for training an excitation model using representation data is illustrated. Apparatus 100 may include a processor 104 communicatively connected to a memory 108. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 104 is configured to instantiate representation generator 112, wherein representation generator 112 is configured to generate representation dataset 116, wherein representation dataset 116 includes plurality of evaluation metrics 120. As used in this disclosure, a “representation generator” is a tunable data structure, such as without limitation a machine-learning model and/or a neural network, that outputs representation dataset 116. As used in this disclosure, a “representation dataset” is information representing system 124. Representation dataset 116 may be a plurality of embeddings in which the vector includes various measurements of cognitive functions. In a non-limiting example, representation dataset 116 may include questionnaires, surveys, and the like. Representation dataset 116 includes plurality of evaluation metrics 120. As used in this disclosure, a “plurality of evaluation metrics” is a quantitative measurement used to assess various aspects of cognitive function. Plurality of evaluation metrics 120 may include one or more numerical fields and/or variables, which could be represented using vectors, and the like. As used in this disclosure, a “vector” as defined in this disclosure is a data structure that represents one or more quantitative values and/or measures the position vector. Such vector and/or embedding may include and/or represent an element of a vector space; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm:

$$l = \sqrt{{\sum }_{i = 0}^{n} {a}_{i}^{2}} ,$$

where ai is attribute number i of the vector. Scaling and/or normalization may function to make vector comparison independent of absolute quantities of attributes, while preserving any dependency on similarity of attributes. A two-dimensional subspace of a vector space may be defined by any two orthogonal vectors contained within the vector space. Two-dimensional subspace of a vector space may be defined by any two orthogonal and/or linearly independent vectors contained within the vector space; similarly, an n-dimensional space may be defined by n vectors that are linearly independent and/or orthogonal contained within a vector space. A vector's “norm’ is a scalar value, denoted ∥a∥ indicating the vector's length or size, and may be defined, as a non-limiting example, according to a Euclidean norm for an n-dimensional vector a as:

$$‖ a ‖ = \sqrt{{\sum }_{i = 0}^{n} {a}_{i}^{2}}$$

In an embodiment, and with continued reference to FIG. 1, plurality of evaluation metrics 120 may be represented by a dimension of a vector space; as a non-limiting example, each element of a vector may include a number representing an enumeration of co-occurrences of first evaluation metric represented by the vector with a second evaluation metric. Alternatively, or additionally, dimensions of vector space may not represent distinct evaluation metrics, in which case elements of a vector representing a first evaluation metric may have numerical values that together represent a geometrical relationship to a vector representing a second evaluation metric, wherein the geometrical relationship represents and/or approximates a semantic relationship between the first evaluation metric and the second evaluation metric. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below.

With continued reference to FIG. 1, the machine learning model may be configured to identify a focus area for system 124 to optimize, prioritize the focus area, and generate representation dataset 116 that further examines the focus area. As used in this disclosure, a “focus area” is a specifically targeted subject or area of interest in a particular domain. Focus area may include one or more targeted subject areas of interest in multiple domains. Identifying the proper focus area of system 124 may include using the results of tracked information using multiple independent sources. Identifying the proper focus area may be a function of a holistic view of system 124. Identifying a focus area may provide a unified understanding of system 124. Identifying the focus area of system 124 may be used to further train representation generator 112 by further tuning representation dataset 116.

Any vectors as described herein may be scaled, such that each vector represents each attribute along an equivalent scale of values. In an embodiment associating representation dataset 116 to one another as described above may include computing a degree of vector similarity among vectors representing plurality of evaluation metrics 120; vector similarity may be measured according to any norm for proximity and/or similarity of two vectors, including without limitation cosine similarity. As used in this disclosure “cosine similarity” is a measure of similarity between two-non-zero vectors of a vector space, wherein determining the similarity includes determining the cosine of the angle between the two vectors. Cosine similarity may be computed as a function of using a dot product of the two vectors divided by the lengths of the two vectors, or the dot product of two normalized vectors. For instance, and without limitation, a cosine of 0° is 1, wherein it is less than 1 for any angle in the interval (0,π) radians. Cosine similarity may be a judgment of orientation and not magnitude, wherein two vectors with the same orientation have a cosine similarity of 1, two vectors oriented at 90° relative to each other have a similarity of 0, and two vectors diametrically opposed have a similarity of −1, independent of their magnitude. As a non-limiting example, vectors may be considered similar if parallel to one another. As a further non-limiting example, vectors may be considered dissimilar if orthogonal to one another. As a further non-limiting example, vectors may be considered uncorrelated if opposite to one another. Additionally, or alternatively, degree of similarity may include any other geometric measure of distance between vectors. In a non-limiting example, plurality of evaluation metrics 120 may include cognitive function metrics, reported metrics from a person, and the like. Plurality of evaluation metrics 120 may include, without limitation, a quantitative metric such as memory performance on a specific task, or a qualitative metric such as how the specific task regarding memory performance was subjectively perceived and/or experienced. Plurality of evaluation metrics 120 may provide valuable insight that helps improve and train the system 124 as defined below.

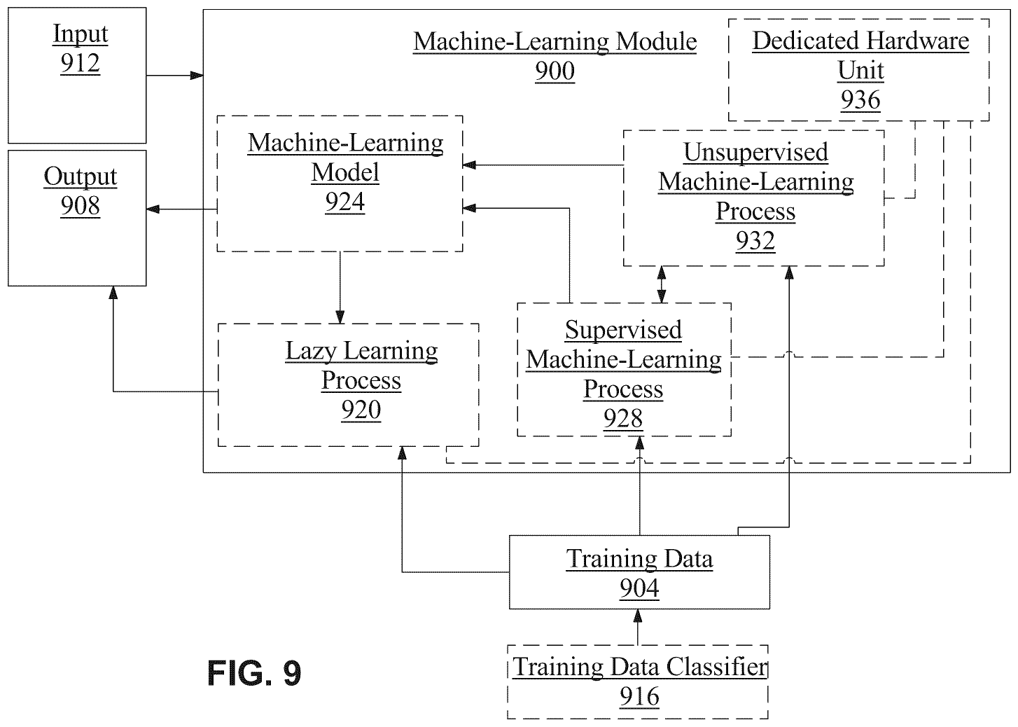

With continued reference to FIG. 1, wherein representation generator 112 includes a machine learning model. Representation generator 112 may perform determinations, classification, and/or analysis steps, methods, processes, or the like as described in this disclosure using machine learning processes. A “machine learning model,” as used in this disclosure, is a process that automatedly uses a body of data known as “training data” and/or a “training set” to generate an algorithm that will be performed by a computing device/module to produce outputs given data provided as inputs; this is in contrast to a non-machine learning software program where the commands to be executed are determined in advance by a user and written in a programming language” as further described in FIG. 9.

With continued reference to FIG. 1, in a non-limiting example, representation generator 112 may identify executive functions to be a focus area that requires attention and/or optimization. In this case, representation generator 112 may prioritize the executive function focus area over other areas of system 124 such as, without limitation, emotional regulation, awareness, metacognition, neuroplasticity, and the like. Further, representation generator 112 may generate representation dataset 116 that further examines the executive functions of system 124 through a plurality of evaluation metrics 120 related to working memory, planning, problem-solving, and the like, as further described below.

Still referring to FIG. 1, processor 104 is further configured to collect a first dataset from system 124. As used in this disclosure, a “first dataset” is an initial collection of data. Without limitation, first dataset may include populated surveys, questionnaires, and the like. First dataset may include information received from system 124, generative data model 136, third party applications, and the like. As used in this disclosure, a “system” is structure that undergoes an iterative process of receiving a stimuli from apparatus 100 and transmitting a response to apparatus 100 to improve the structure's function. In a non-limiting embodiment, representation dataset 116 is transmitted to system 124 and system 124 completes and fills out plurality of evaluation metrics 120 involving, without limitation, surveys, questionnaires, training sessions, video modules, and the like.

With continued reference to FIG. 1, the first dataset may include receiving information from generative data model 136. As used in this disclosure, a “generative data model” is a generative artificial intelligent system that uses machine learning algorithms to create, establish, or otherwise generate data, such as, without limitation, first dataset and/or the like in any data structure as described herein (e.g., text, image, video, audio, among others) that is similar to one of more provided training examples.

With continued reference to FIG. 1, in one or more embodiments, computing device may implement one or more aspects of “generative artificial intelligence (AI),” a type of AI that uses machine learning algorithms to create, establish, or otherwise generate data such as, without limitation, first dataset and/or the like in any data structure as described herein (e.g., text, image, video, audio, among others) that is similar to one or more provided training examples. In an embodiment, machine learning module described herein may generate one or more generative machine learning models that are trained on one or more set of representation dataset 116. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

With continued reference to FIG. 1, in some cases, generative machine learning models may include one or more generative models. As described herein, “generative models” refers to statistical models of the joint probability distribution P(X, Y) on a given observable variable x, representing features or data that can be directly measured or observed (e.g., representation dataset 116) and target variable y, representing the outcomes or labels that one or more generative models aims to predict or generate (e.g., first dataset). In some cases, generative models may rely on Bayes theorem to find joint probability; for instance, and without limitation, Naïve Bayes classifiers may be employed by computing device to categorize input data such as, without limitation, first dataset into different categories such as, without limitation, habit data related to different areas of life including, without limitation, work habits, exercise habits, learning habits, relationship habits, eating habits, and the like.

In a non-limiting example, and still referring to FIG. 1, one or more generative machine learning models may include one or more Naïve Bayes classifiers generated, by computing device, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing Device may then calculate a likelihood table by calculating probabilities of different data entries and classification labels. Computing device may utilize a naïve Bayes equation to calculate a posterior probability for each class. A class containing the highest posterior probability is the outcome of prediction.

With continued reference to FIG. 1, although Naïve Bayes classifier may be primarily known as a probabilistic classification algorithm; however, it may also be considered a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine learning models may include one or more Naïve Bayes classifiers to generate new examples of first dataset based on other user's scores, wherein the models may be trained using training data containing a plurality of features of first dataset, and/or the like as input correlated to a plurality of labeled classes e.g., high score, medium score, low score as output.

With continued reference to FIG. 1, some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 9.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 9 to distinguish between different categories e.g., actual data vs simulated data, or states e.g., ACTUAL vs. SIMULATED within the context of generated data such as, without limitations, first dataset, and/or the like. In some cases, computing device may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real first dataset. In some cases, GAN may be configured to receive representation dataset 116 such as, without limitation, plurality of evaluation metrics 120 which may include questionnaires, surveys, and other qualitative metrics to evaluate the system, as input and generates corresponding first dataset containing information describing or evaluating the performance of plurality of evaluation metrics 120. On the other hand, discriminator of GAN may evaluate the authenticity of the generated content by comparing it to real first dataset, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by computing device to model complex relationships between representation dataset 116 e.g., plurality of evaluation metrics 120 which may include questionnaires, surveys, and other qualitative metrics to evaluate the system. In some cases, VAE may encode input data into a latent space, capturing first dataset. Such encoding process may include learning one or more probabilistic mappings from observed representation dataset 116 to a lower-dimensional latent representation. Latent representation may then be decoded back into the original data space, therefore reconstructing the representation dataset 116. In some cases, such decoding process may allow VAE to generate new examples or variations that are consistent with the learned distributions.

Additionally, or alternatively, one or more generative machine learning models may utilize one or more predefined templates representing, for example, and without limitation, correct first dataset. In a non-limiting example, one or more first dataset template (i.e., predefined models or representations of correct and ideal wellbeing metrics) may serve as benchmarks for comparing and evaluating plurality of representation dataset 116.

Still referring to FIG. 1, computing device may configure generative machine learning models to analyze input data such as, without limitation, plurality of evaluation metrics 120 which may include questionnaires, surveys, and other qualitative metrics to evaluate the system to one or more predefined templates such as first dataset template representing correct first dataset described above, thereby allowing computing device to identify discrepancies or deviations from first dataset. In some cases, computing device may be configured to pinpoint specific errors in plurality of evaluation metrics 120 which may include questionnaires, surveys, and other qualitative metrics to evaluate the system or any other aspects of plurality of evaluation metrics 120. In some cases, errors may be classified into different categories or severity levels. In a non-limiting example, some errors may be considered minor, and generative machine learning model such as, without limitation, GAN may be configured to generate first dataset contain only slight adjustments while others may be more significant and demand more substantial corrections. In some embodiments, computing device may be configured to flag or highlight representation dataset 116 needing attention, altering the system to change behaviors or complete additional actions, directly on the representation dataset 116 using one or more generative machine learning models described herein. In some cases, one or more generative machine learning models may be configured to generate and output indicators such as, without limitation, visual indicator, audio indicator, and/or any other indicators as described above. Such indicators may be used to signal the detected error described herein.

Still referring to FIG. 1, in some cases, one or more generative machine learning models may also be applied by computing device to edit, modify, or otherwise manipulate existing data or data structures. In an embodiment, output of training data used to train one or more generative machine learning models such as GAN as described herein may include plurality of evaluation metrics that linguistically or visually demonstrate modified representation dataset e.g., surveys and questionnaires that address different cognitive function areas than previously addressed, and/or the like. In an embodiment, output of training data used to train one or more generative machine learning models such as GAN as described herein may include simulated datasets that linguistically or visually demonstrate modified representation data e.g., varying types of evaluation metrics, and/or the like. In some cases, first dataset may be synchronized with plurality of evaluation metrics, for example, and without limitation, in a side-by-side arrangement with the system input data. Additionally, or alternatively, second dataset may be generated using generative machine learning models to address the error signal. In some cases, such second dataset may be integrated with the representation dataset, offering user a multisensory instructional experience.

Additionally, or alternatively, and still referring to FIG. 1, computing device may be configured to continuously monitor representation dataset 116. In an embodiment, computing device may configure discriminator to provide ongoing feedback and further corrections as needed to subsequent input data (e.g., modified representation dataset 116). In some cases, one or more sensors such as, without limitation, wearable device, motion sensor, or other sensors or devices described herein may provide additional representation dataset 116 that may be used as subsequent input data or training data for one or more generative machine learning models described herein. An iterative feedback loop may be created as computing device continuously receive real-time data, identify errors as a function of real-time data, delivering corrections based on the identified errors, and monitoring system response on the delivered corrections. In an embodiment, computing device may be configured to retrain one or more generative machine learning models based on system response or update training data of one or more generative machine learning models by integrating system response into the original training data. In such embodiment, iterative feedback loop may allow machine learning module to adapt to the user's needs, enabling one or more generative machine learning models described herein to learn and update based on system response and generated feedback.

With continued reference to FIG. 1, other exemplary embodiments of generative machine learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models that may be used to generate simulated data.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by computing device to generate first dataset. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine learning models that may be used to create simulated data described herein. As an ordinary person skilled in the art, upon reviewing the entirety of this disclosure, will be aware of various multi-model neural network and combination thereof that may be implemented by apparatus 100 in consistent with this disclosure.

Still referring to FIG. 1, processor 104 generates, using representation generator 112 and the first dataset, a first representation dataset. As used in this disclosure, a “first representation dataset” is an initial dataset generated by representation generator 112 and first dataset provided by system 124. The first representation dataset may include plurality of evaluation metrics 120. The first representation dataset may be used as training data for excitation model 140. The first representation dataset may also be used in conjunction with first dataset to generate error signal 148, as discussed in more detail below, to further tune representation generator 112.

With continued reference to FIG. 1, wherein representation generator 112 may be iteratively trained on a plurality of datasets as a function of the representation dataset. As used in this disclosure, a “plurality of datasets” is a collection of information from a source. The plurality of datasets may include a first dataset, a second dataset, and the like. The plurality of datasets may include input from system 124, input from generative data model 136, and input from any other source. As used in this disclosure, “system input” refers to any information transmitted to apparatus 100 by system 124. System input may include any configuration of data provided by system 124. In a non-limiting example, system input may include sensor inputs, including, but not limited to, sensor input related to machinery, electronic circuits, digital circuits, and the like. System input may also include user input as a function of a client device which may include text, digital images, audio recordings, videos, and the like.

With continued reference to FIG. 1, a device may include different hardware for specific measurements. Some nonlimiting examples of hardware are transducers, sensors, and actuators. For the purposes of this disclosure, a “transducer” is a device used to transform one kind of energy into another. When a transducer converts a quantity of energy to an electrical voltage or an electrical current it is called a sensor. A measurable quantity of energy may include sound pressure, optical intensity, magnetic field intensity, thermal pressure, etc. When a transducer converts an electrical signal into another form of energy such as sound, light, mechanical movement, it is called an actuator. It should be noted that sound is incidentally a pressure field. Actuators allow the use of feedback at the source of the measurements.

With continued reference to FIG. 1, a sensor may be considered as a component or with a collection of electronics such as amplifiers, decoders, filters, computer devices and device. For the purposes of this disclosure an “instrument” is a sensor bundled with its associated electronics. However, in some embodiments, sensors may be further integrated with device. A sensor may be integrated with system 124.

With continued reference to FIG. 1, a sensor integrated with device may be linear so that response y to a stimulus x is in the form: y(x)=Ax, 0<x<xₘₐₓ, A>0. It should be noted, there is a presumption that the stimulus to be positive. A is the sensitivity of the transducer gain, or the gain of the sensor. The gain is presumed to be positive for which the linear model satisfies the definition of linearity: y(x+z)=A(x+z)=y(x)+y(z). It should be noted that this example is an idealized form of a sensor and may extend beyond the linearity constraints which may include time dependency, memory, and its output keeping track of input. A more generalized sensor may include the steady state transfer function of the sensor. For this case, the sensitivity can be defined as the derivative of the output with respect to the input

$$S = \frac{\partial y}{\partial x} .$$

In this example, the sensor exhibits sensitivities to other operating parameters (i.e. supply voltage) or temperature. For the purposes of this disclosure, “sensitivity” is the ratio of output to input. This can include electrical output and signal input or an input transducer. It can also include physical output to an electrical input, or an output transducer. Sensitivity can also be used in its usual electrical meaning. In this it would refer to a percent change of a property of a device because of a percent change in a parameter. In some embodiments this would be a percent change in gain as a result of percent change in ambient temperature. This type of sensitivity may be referred to as the Gain of a sensor.

Still referring to FIG. 1, a device with integrated sensors may not respond to arbitrarily small signals. Device may respond to signals within a specified range from zero to a sensor threshold which does not cause the output of the sensor to change. The existence of a threshold relates to the nonlinear behavior of the device and the noise. A device with an integrated sensor may fail to respond to stimuli which are arbitrarily large as well. In this case, device integrated with a sensor may have a max range. The full range of device integrated with a sensor may be limited by compression or clipping. Compression and clipping are results of nonlinearity and thus may include device as a nonlinearity device.

Still referring to FIG. 1, referring to the linear equation above assuming a linear sensor is improved with the addition of a constant: y(x)=b₀+Ax. It should be noted that the equation is not linear even though it is described as a first order polynomial. The constant is called a zero offset and can be defined in two ways: a sensor reading when the input is zero, or the value of the stimulus required to make the output zero. The zero offset is corrected by subtracting b₀ from y and recovering the linear description of a sensor: y′(x)=y(x)−b₀=Ax.

With continued reference to FIG. 1, device may include very fast measurements where it can internally store energy. Device's output may depend on previous measurements the integrated sensors make. It should be noted that the sensor may exhibit memory. The time dependence of a sensor can be linear if the response is described by a linear differential equation:

$${\sum }_{n = 0}^{N} {A}_{n} \frac{{\partial }^{n} y}{\partial {t}^{n}} = {\sum }_{k = 0}^{k} {B}_{k} \frac{{\partial }^{k} x}{\partial {t}^{k}} .$$

Taking the Laplace transform of this equation:

$$y ( s , X ) = ( \frac{{\sum }_{k = 0}^{K} {B}_{k} {S}^{k}}{{\sum }_{n = 0}^{N} {A}_{n} {S}^{n}} ) x = H ( s ) X ( s ) ,$$

which is in Laplace transform space and the sensor response is still linear in stimulus x. The response of a sensor with a transfer function H(s) at time/is the convolution integral between the history of the stimulus x and the inverse Laplace transform h(t) of H(s):

$$y ( t ) = {\int }_{0}^{∞} h ( τ ) x ( t - τ ) d τ .$$

Device may behave like a low pass filter, wherein there is a delayed response to their input. There is a limit to the maximum stimulus frequency that can be detected. The maximum frequency a sensor can interpret is approximately the inverse of its response time.

With continued reference to FIG. 1, system input may also include any data obtained and or provided by third party applications. As used in this disclosure, a “third party application” is a software application developed by an entity other than the primary system vendor or integrator. In some cases, third party applications may include additional, non-essential functions and may not be part of core system software. In some cases, third party applications may require a specific runtime environment to function known as the “proprietary runtime environment.” In some cases, proprietary runtime environment may include one of more libraries, services, or other dependencies that are unique to applications, and not necessarily shared with other parts of the system. In a non-limiting example, in some cases, third party applications may access, receive, and transmit any information to apparatus 100.

Still referring to FIG. 1, processor 104 outputs excitation element 144 from excitation model 140 using the first dataset. As used in this disclosure, an “excitation model” is a machine learning process that provides system 124 with recommendations on how to improve their score on plurality of evaluation metrics 120 using excitation element 144. As used in this disclosure, an “excitation element” is the output generated by the excitation model 140. Excitation element 144 may include specific system 124 recommendations in areas of life such as, without limitation, the system's awareness, executive functions, metacognition, emotional regulation, neuroplasticity, and any other area of life described herein. Awareness, as used herein, involves a state or ability to perceive, feel, or be conscious of a one's surroundings. Without limitation, this may include awareness of objects, an environment, situations, other people and their thoughts and/or emotions, one's internal thoughts and/or emotions, and the like. In a non-limiting example, excitation model 140 may include a list of strategies and/or assignments for system 124 to increase awareness by, for instance, meditating for longer durations of time and/or more consistently, watch recommended training videos and/or podcasts to learn about awareness, read a recommended book and/or article related to improving awareness, breathing techniques, listening exercises, and the like. Executive functions, as used herein, involve cognitive control, working memory, inhibition, error detection, and the like. In a non-limiting example, excitation model 140 may include a list of strategies and/or assignments for system 124 to improve executive functions by, for instance, N-back tasks, Stroop tasks, other cognitive training games, and the like, to measure and improve system 124 working memory and attention. An N-back task requires a user to recognize items that have been presented n-steps before. The users must memorize the sequence of items in order to discover those repetitions that span multiple items. In a non-limiting example, a user is given a series of stimuli, such as letters, and the user is asked to indicate whether the current letter matches the letter presented “N” steps back in the sequence. The value of “N” determines how many steps back in the sequence the user is required to remember. As the value of “N” increases, the task becomes more challenging because the user must remember a larger amount of information in their working memory, thereby exercising the user's memory muscle. The Stroop task combines words and colors to generate incongruent and congruent stimuli. An example, without limitation, of a congruent stimulus may include the word “blue” written in blue ink. When the user is instructed to name the color of the ink of the congruent stimulus where there is no interference between the color (blue) and the word (blue). An example, without limitation, of an incongruent stimuli may include the word “blue” written in yellow ink. When the user is instructed to name the color of the ink of the incongruent stimulus where there is an interference between the color (yellow) and the word (blue). The Stroop Test measures how fast a user can read aloud only the color of a word, of an incongruent stimuli. The Stroop Test helps provide insight as to how a user uses selective attention to focus on relevant information and ignore conflicting information and may also improve user attention. Metacognition relates to monitoring and regulating a cognitive process. Without limitation, metacognition may include setting goals, self-reflection, and learning from previous mistakes. In a non-limiting example, excitation model 140 may include a list of strategies and/or assignments for system 124 to improve metacognition by, for instance, journaling about the user's week at work and how that made the user feel, reflecting on user's own learning process through a questionnaire, setting goals and outlining actions that are required to meet those goals, and the like. Emotional regulation is the ability to understand one's own feelings and make behavioral choices to counteract, balance, or put a person back into a harmonious emotional state. In a non-limiting example, excitation model 140 may include a list of strategies and/or assignments for system 124 to improve emotional regulation by, for instance, surveys that help system 124 understand their emotions, questionnaires that help system 124 recognize certain emotional triggers and the subsequent actions, mindfulness practices, learning soothing techniques (e.g., listening to music, breathing techniques, and the like), assigning system 124 tasks that support problem solving, gratitude practices, progressive exposure techniques, and the like. Neuroplasticity is the brain's ability to form and reorganize synaptic connections. In a non-limiting example, excitation model 140 may include a list of strategies and/or assignments for system 124 to improve neuroplasticity by, for instance, learning new skills, engage in physical activity (e.g., running, biking, working out, and the like), cognitive trainings (as discussed above), mindfulness practices, building relationships, monitoring nutrition and diet, reducing stress, ensuring system 124 gets enough sleep, and the like.

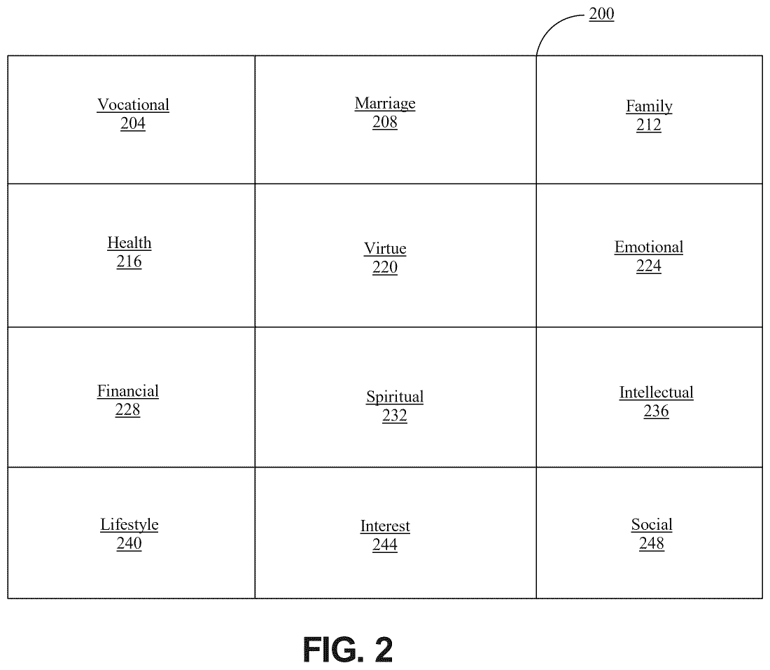

With continued reference to FIG. 1, excitation element 144 may also include specific system 124 recommendations in areas of life such as, without limitation, the system's physical health domain, social relationship domain, work and career domain, education and personal development domain, leisure and recreation domain, spirituality and religion domain, community engagement domain, personal finances domain, and the like. The physical health domain may include activities related to the system's diet, exercise, sleep, hygiene, medical care, and overall health status. In a non-limiting example, the physical health domain may include eating a balanced diet of fruits, vegetables, whole grains, lean protein and healthy fats. Without limitation, in another example, the physical health domain may include engaging in regular physical activities such as, walking, jogging, swimming, biking, strength training, and the like. In another non-limiting example, the physical health domain may include information related to sleep, where sleep is prioritized to help support a healthy mind. In another non-limiting example, the physical health domain may include routine checkups with a physician, seeking preventative care, medical treatment, and maintaining a healthy body. In another non-limiting example, the physical health domain may include hygienic practices such as frequent handwashing, dental hygiene, and general grooming practices. The social relationship domain may include system 124 relationship and connection with friends, family, partners, colleagues, and the community. The social relationship domain may include aspects of the relationship intimacy, social cohesion, social tensions, feelings of belonging, and the like. In another non-limiting example, the social relationship domain may include relationship with family members like mothers, fathers, brothers, sisters, cousins, children, spouses, extended family, and the like. Without limitation, the social relationship domain may also include information related to friendships, such as, building and maintaining friendships with peers, confidants, and social support networks. In a non-limiting example, the social relationship domain may also include romantic partnership relationships and include information related to cultivating those intimate relationships, shared goals, and the like. The work and career domain may include system 124 relationship with colleagues, current, former, and/or future role at a company, job satisfaction, salary, career development, and the like. In one or more embodiment, the work and career domain may include system 124 goals for the next 5 years related to their career development and/or information related to their current career. In another non-limiting example, the work and career domain may include information related to employment opportunities, personal interests, skills, values, and the like. Without limitation, the work and career domain may also include information related to expertise and competence in a chosen profession, setting career goals, seeking advancement opportunities, investing in personal growth and development, work-life balance, overall fulfillment of the occupation, and the like. The education and personal development domain may include system 124 skill acquisition, intellectual growth, learning, and the like. In one or more embodiment, the education and personal development domain may include system 124 personal goals, course work for an institution, certifications, and the like. In one or more embodiments, the education and personal development domain may include information related to lifelong learning in the form of formal education, vocational training, information learning, apprenticeships, and the like. In a non-limiting example, the education and personal development domain may also include problem solving activities, creative expression, setting personal goals in health/relationships/intellectual/etc., self-improvement activities, and the like. The leisure and recreation domain may include system 124 hobbies, vacation, entertainment, and the like. In a non-limiting example, the leisure and recreation domain may include system 124 attending certain events, and or activities, like Pilates, yoga, journaling, a football game, a movie premiere, spa trips, vacations abroad, and the like. In another non-limiting example, the leisure and recreation domain may also include information related to painting, gardening, playing musical instruments, cooking, experiencing new cultures, writing, sports, listening to music, self-expression, and the like. The spirituality and religion domain may include system 124 beliefs, rituals, practices, values, faith, love, truth, morals, beauty, justice, charity, goodness, and the like. In a non-limiting example, the spirituality and religion domain may include information related to system 124 engagement with organized religion, or spiritual rituals, prayer, connection to purpose, reflection, repentance, forgiveness, meditation, and the like. In another non-limiting example, the spirituality and religion domain may include information related to existential questions, philosophical perspectives, worship, spiritual communities, mindfulness, contemplative practices to cultivate inner peace, presence, and spiritual awareness, and the like. The community engagement domain may include activities where system 124 has contributed to and/or worked with others in their environment. In a non-limiting example, the community engagement domain may include community events, volunteering activities, advocacy, social activism, civic duties, generally contributing to the common good, and the like. In one or more embodiments, the community engagement domain may include working with nonprofit groups, speaking out on behalf of social justice, human rights, property rights, public service, and/or other causes, and the like. The personal finances domain may include information related to system 124 assets in bank accounts, money market accounts, public markets, real estate, private markets, alternatives and other investments. In a non-limiting example, the personal finances domain may include information related to compensation level, financial management, budgeting, wealth accumulation, retirement goals, material possessions, access to resources and amenities, and the like. In one or more embodiment, the area of life domains may overlap on one or more subject area. In a non-limiting example, domain may include any domain described in this disclosure, including those described with reference to FIG. 2.

With continued reference to FIG. 1, excitation model 140 may include a large language model. As used in this disclosure, a “large language model (LLM)” is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, without limitation, system 124 input, generative data model 136 input, third party applications input, which may include information related to cognitive function, cognitive health, ways to improve cognition generally, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments the large language model may include and/or be produced using a generative pretrained transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “I am feeling,” then it may be highly likely that the word “happy” or “sad” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It is also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers May allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with representation dataset 116.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, training excitation model 140 may further include a neural network. As used in this disclosure, a “neural network” is a method in artificial intelligence that teaches computers to process data in a way that is inspired by the human brain. It is a type of machine learning process, called deep learning, which uses interconnected nodes or neurons in a layered structure that resembles the human brain, as discussed more in detail below.

Still referring to FIG. 1, processor 104 transmits excitation element 144 to system 124. Excitation element 144 may provide system 124 with any data and/or information using text, video, graphics, and the like. Excitation element 144 may include suggestions and/or feedback for system 124 to further optimize various functions. As used in this disclosure, “feedback” is any information that conveys useful data to a system regarding the results of a specified performance metric. In a non-limiting example, feedback may be organized and displayed to system 124 through graphical user interface as an image, text, report, audio clip, video clip, and the like. For instance, and without limitation, feedback may include a written report of system 124 progress in a certain area, such as, executive function, wherein system 124 receives various rankings for working memory progress, organization progress, problem solving progress, and the like. Additionally, this may include visual graphics and/or video clips that explain why and/or how system 124 performed and how system 124 can further improve performance. Feedback may also include, without limitation, suggestions as to different activities to engage in throughout the week with an explanation of why these activities are suggested to system 124. Feedback is critical to system 124 improvement, thereby reducing error signal 148 and aligning actual system to the target system.

As used in this disclosure, “suggestions” refer to recommendations based on specific information related to a particulate subject matter. In a non-limiting example, convergent outcome may provide suggestions to assist system 124 with overall cognitive function improvements. As used in this disclosure, “system functions” refer to various areas of cognitive function within a system. For instance, and without limitation, system functions may refer to attention, awareness, executive functions, and the like.

With continued reference to FIG. 1, excitation element 144 is presented to system 124 through a graphical user interface, wherein the graphical user interface is configured to display a data structure to the system using a display device. As used in this disclosure, a “graphical user interface (GUI)” is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

As used in this disclosure, a “data structure” is a way of organizing data represented in a specialized format on a computer configured such that the information can be effectively presented in a graphical user interface. In some cases, the data structure includes any input data. In some cases, the data structure contains data and/or rules used to visualize the graphical elements within a graphical user interface. In some cases, the data structure may include any data described in this disclosure. In some cases, the data structure may be configured to modify the graphical user interface, wherein data within the data structure may be represented visually by the graphical user interface. In some cases, the data structure may be continuously modified and/or updated by processor 104, wherein elements within graphical user interface may be modified as a result. In some cases, processor 104 may be configured to transmit system 124 the data structure. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. Processor 104 may transmit the data described above to a database wherein the data may be accessed from the database. Processor 104 may further transmit the data above to a display device, client device, or another computing device.

With continued reference to FIG. 1, as used in this disclosure, a “display device” is a device configured to show visual information. In some cases, display device may include a liquid crystal display (LCD), a cathode ray tube (CRT), a plasma display, a light emitting diode (LED) display, and any combinations thereof. Display device may include, but is not limited to, a smartphone, tablet, laptop, monitor, tablet, and the like. Display device may include a separate device that includes a transparent screen configured to display computer generated images and/or information. In some cases, display device may be configured to present a graphical user interface to a user, wherein a user may interact with a graphical user interface. In some cases, a user may view a graphical user interface through display. In a non-limiting example, display device may include a client device. As used in this disclosure, a “client device” is a device that accesses and interacts with apparatus 100. For instance, and without limitation, client device may include a remote device and/or apparatus 100. In a non-limiting embodiment, client device may be consistent with a computing device as described in the entirety of this disclosure. System input may also include information from third party applications.

The data structure may include vector space, matrix, and the like. A “vector” as defined in this disclosure is a data structure that represents one or more quantitative values and/or measures the position vector. Such vector and/or embedding may include and/or represent an element of a vector space; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where ai is attribute number I of the vector. Scaling and/or normalization may function to make vector comparison independent of absolute quantities of attributes, while preserving any dependency on similarity of attributes. A two-dimensional subspace of a vector space may be defined by any two orthogonal vectors contained within the vector space. Two-dimensional subspace of a vector space may be defined by any two orthogonal and/or linearly independent vectors contained within the vector space; similarly, an n-dimensional space may be defined by n vectors that are linearly independent and/or orthogonal contained within a vector space. A vector's “norm’ is a scalar value, denoted ∥a∥ indicating the vector's length or size, and may be defined, as a non-limiting example, according to a Euclidean norm for an n-dimensional vector a as:

$$‖ a ‖ = \sqrt{{\sum }_{i = 0}^{n} {a}_{i}^{2}}$$

As used in this disclosure “matrix” is a rectangular array or table of numbers, symbols, expressions, vectors, and/or representations arranged in rows and columns. For instance, and without limitation, matrix may include rows and/or columns comprised of vectors representing image data, where each row and/or column is a vector representing a distinct data element of image data; a distinct data element of image data represented by vectors in matrix may include a digitalized image of a slide of cell tissues, including without limitation various aspects of the slide like cell type, cell count, and the like.

Matrix may be generated by performing a singular value decomposition function. As used in this disclosure a “singular value decomposition function” is a factorization of a real and/or complex matrix that generalizes the eigen decomposition of a square normal matrix to any matrix of m rows and n columns via an extension of the polar decomposition. For example, and without limitation singular value decomposition function may decompose a first matrix, A, comprised of m rows and n columns to three other matrices, U, S, T, wherein matrix U, represents left singular vectors consisting of an orthogonal matrix of m rows and m columns, matrix S represents a singular value diagonal matrix of m rows and n columns, and matrix VT represents right singular vectors consisting of an orthogonal matrix of n rows and n columns according to the vectors consisting of an orthogonal matrix of n rows and n columns according to the function:

$${A}_{mxn} = {U}_{mxm} {S}_{mxn} {V}_{nxn}^{T}$$

singular value decomposition function may find eigenvalues and eigenvectors of AA^{T} and A^{T}A. The eigenvectors of A^{T}A may include the columns of IT, wherein the eigenvectors of AA^{T} may include the columns of U. The singular values in S may be determined as a function of the square roots of eigenvalues AA^{T} or A^{T}A, wherein the singular values are the diagonal entries of the S matrix and are arranged in descending order. Singular value decomposition may be performed such that a generalized inverse of a non-full rank matrix may be generated.

With continued reference to FIG. 1, the graphical user interface may include a plurality of visual elements associated with a plurality of event handlers. As used in this disclosure, a “plurality of visual elements” is a digital element displayed using a graphical user interface. In a non-limiting example, visual representation may be associated with one or more event handlers. In another non-limiting example, visual representation may include components capable of user interaction. In some cases, user interaction with visual element may include clicking a text box or other clickable buttons that allow user to input information and/or interact with other visual representations. As used in this disclosure, a “plurality of event handlers” is a module, data structure, function, and/or routine that performs an action on remote device in response to a user interaction with event handler graphic. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements. In a non-limiting example. Plurality of event handlers may be associated with different functions in graphical user interface, including, data transmission of system 124 surveys to a display device from system 124.

Still referring to FIG. 1, processor 104 collects a second dataset from system 124. As used in this disclosure, a “second dataset” is a separate collection of data distinct and independent from first dataset. Second dataset may include overlapping information as first dataset and/or new information. Second dataset may be a product of iterative representation dataset 116 generated by representation generator 112. In a non-limiting example, second dataset may be transmitted by system 124 through graphical user interface through a display device. In another non-limiting example, second dataset may be transmitted by generative data model 136 and/or third party applications. Excitation model 140 is retrained on the second dataset in order to generate a more accurate excitation element 144, wherein the excitation element 144 may provide more accurate feedback to system 124. In a non-limiting example, retraining excitation model 140 permits excitation model 140 to continuously learn about system 124 and which areas or system 124 cognitive functions require work and improvement. In another example, without limitation, retraining excitation model 140 may also provide insight as to trends with system 124 cognitive functions which may be leveraged by excitation model 140 to predict future behaviors based on system 124 history.

Still referring to FIG. 1, processor 104 generates error signal 148 as a function of the second dataset and representation dataset 116. As used in this disclosure, an “error signal” is the difference between a target outcome and an actual outcome of a system. In a non-limiting example, error signal 148 is used to tune representation generator 112 iteratively so that representation generator 112 produces representation dataset 116 that corrects system 124 functions. For instance, without limitation, error signal 148 may indicate that the actual system (system 124) is lacking in the executive function category compared to the target system, and thereby send this indication to representation generator 112 to create representation dataset 116 that includes more questions, surveys, trainings, and the like in the executive function category for system 124 to complete to aid in adjusting system 124 to improve executive functions. In another non-limiting example, error signal 148 may indicate a deficiency in the actual system (system 124) emotional state compared to the target system. This information from error signal 148 is transmitted to representation generator 112, wherein representation generator 112 will further adjust the representation dataset 116 to produce more focused plurality of evaluation metrics 120 associated with emotional state. This adjustment of the representation dataset 116 may further aid system 124 in prioritizing emotional health and wellbeing through various exercises, trainings, questions, and the like related to emotional state.

Still referring to FIG. 1, processor 104 modifies representation generator 112 using error signal 148, wherein modifying representation generator 112 is configured to generate at least a modified evaluation metric. As used in this disclosure, a “modified representation generator” is a representation generator with at least a modified evaluation metric. As used in this disclosure, a “modified evaluation metric” is a revised parameter used to evaluate a systems performance. In a non-limiting example, modified evaluation metrics may include one or more changes to the evaluation metrics or representation dataset 116. For example, and without limitation, a modified evaluation metric may include a reprioritization of cognitive categories to focus on, such as, changing the questions, surveys, and the like from a focus on system 124 emotional state to system 124 executive function.

Still referring to FIG. 1, processor 104 outputs a second representation dataset using the modified representation generator. As used in this disclosure, a “second representation dataset” is a subsequent dataset generated by representation generator 112 and second dataset provided by system 124. The second representation dataset may include plurality of evaluation metrics 120. The second representation dataset may be used as training data for excitation model 140. The second representation dataset may also be used in conjunction with second dataset to generate error signal 148, as discussed in more detail below, to further tune representation generator 112.

Still referring to FIG. 1, processor 104 outputs a second excitation element from excitation model 140 using the second representation dataset. As used in this disclosure, a “second excitation element” is an output generated by the excitation model 140 subsequent to an initial excitation element. As previously mentioned, excitation element 144 may include specific system 124 recommendations in areas of life such as, without limitation, the system's awareness, executive functions, metacognition, emotional regulation, neuroplasticity, and any other area of life as described herein.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Referring now to FIG. 2, exemplary domains 200 are illustrated by way of a table. As can be seen domains may include vocational 204, marriage 208, family 212, health 216, virtue 220, emotional 224, financial 228, spiritual 232, intellectual 236, lifestyle 240, interest 244, and social 248 to name a few. Each domain 200 may have a status. Exemplary, non-limiting statuses include breakthrough, emerging, growth, plateau, stagnation, and depletion to name a few. In some cases, a domain status may be determined according to one or more state variables. State variable may be affected by objective data and/or subjective data. Exemplary non-limiting examples of objective data include medical measurements, time spent on certain activities, events participated in, number of steps taken, and generally speaking anything that can be measured. In some cases, remote device may directly measure or infer objective data, for example remote device may measure number of steps taken by system, amount of screen time, and the like. Alternatively or additionally objective data may be input by system into remote device. For example, a system may include system weight, system blood pressure, or any other objective datum by way of remote device. In some cases, system may input subjective data, for example by way of remote device. Subjective data may include a numerical representation (e.g., 1-10 rating) of how a system thinks or feels about a current aspect relating to a domain. For example a system may rate a level of anxiety, a level of fulfilment, or the like. In an embodiment, one or more domains may be selected and/or isolated by a system. This may allow for a more focused and concentrated experience on one or more domains of interest to a system. In an embodiment, a system may select one or more domains to isolate and/or focus on. In yet another non-limiting example, computing device may select one or more domains for a system to focus on, using a selection process that may include one or more machine learning processes as described throughout this application.

With continued reference to FIG. 2, at least a domain may include vocational domain 204. Objective data that may be associated with vocational domain includes title, role, responsibility, compensation, and the like. Subjective data may include a rating of system's level of vocational fulfilment. A domain target associated with vocational domain 204 may include a change in a subjective or objective datum associated with the vocational domain 204. Schedule components or events that may be added to exploit value in vocational domain 204 include professional training events, maximizing contribution, exploiting opportunities, and the like.

With continued reference to FIG. 2, at least a domain may include marriage domain 208. Objective data that may be associated with marriage domain includes amount of time spent with spouse, for example time spent enjoying one another. Subjective data may include a rating of system's level of marriage fulfilment. A domain target associated with marriage domain 208 may include a change in a subjective or objective datum associated with the marriage domain 208. Schedule components or events that may be added to exploit value in marriage domain 208 include events determined to maximize marriage fulfilment, including participating in couple centric events, self-sacrificial acts of love, couples therapy, honest communication sessions, and the like.

With continued reference to FIG. 2, at least a domain may include family domain 212. Objective data that may be associated with family domain includes amount of time spent with family. Subjective data may include a rating of system's level of family fulfilment or a rating of a family member's level of fulfilment with system/spouse. A domain target associated with family domain 212 may include a change in a subjective or objective datum associated with the family domain 212. Schedule components or events that may be added to exploit value in family domain 212 include events determined to maximize family fulfilment, including participating in family events, self-sacrificing acts of love, generosity of time, money, and service, and the like.

With continued reference to FIG. 2, at least a domain may include health domain 216. Objective data that may be associated with health domain includes medical data, such as without limitation body mass index, blood pressure, resting heart rate, blood oxygen content, and the like. Subjective data may include a rating of system's level of health fulfilment, a rating of number of activities a system feels are impaired by health concerns, a rating of overall concern with health, and the like. A domain target associated with health domain 216 may include a change in a subjective or objective datum associated with the health domain 216. Schedule components or events that may be added to exploit value in health domain 216 include events determined to maximize health fulfilment, exercise, nutritional meals, visits to medical professionals, and the like.

With continued reference to FIG. 2, at least a domain may include virtue domain 220. Objective data that may be associated with virtue domain includes amount of time acting virtuously, proportion of big decisions which are aligned with desirable virtues, amount of success or failure living within targeted virtue levels, evidence of retained or unretained resolve, and the like. Subjective data may include a rating of system's self-perceived level of virtue or a rating of system's perceived level of virtue from another. A domain target associated with virtue domain 220 may include a change in a subjective or objective datum associated with the virtue domain 220. Schedule components or events that may be added to exploit value in virtue domain 220 include events determined to maximize virtue fulfilment, including participating habit building exercises designed to facilitate consistently good decision making.

With continued reference to FIG. 2, at least a domain may include emotional domain 224. Objective data that may be associated with emotional domain includes amount of time spent in a state of emotional destress, amount of time in emotional harmony, amount of time sleeping, caloric intake, amount of time engaged in anxiety about the past or imagined future, and the like. Subjective data may include a rating of system's level of emotional fulfilment. A domain target associated with emotional domain 224 may include a change in a subjective or objective datum associated with the emotional domain 224. Schedule components or events that may be added to exploit value in emotional domain 224 include therapy, treatment under the supervision of health care professionals, events and exercises that are likely to improve a system's emotions, and the like.

With continued reference to FIG. 2, at least a domain may include financial domain 228. Objective data that may be associated with financial domain includes amount of financial assets possessed by system. Subjective data may include a rating of system's sense of financial security independence and freedom. A domain target associated with financial domain 228 may include a change in a subjective or objective datum associated with the financial domain 228. Schedule components or events that may be added to exploit value in financial domain 228 include meeting with a financial advisor, increasing savings contributions, budgeting, and the like.

With continued reference to FIG. 2, at least a domain may include intellectual domain 236. Objective data that may be associated with intellectual domain includes amount performance in intellectual pursuits, such as graded performance in school. Subjective data may include a rating of system's level of intellectual fulfilment. A domain target associated with intellectual domain 236 may include a change in a subjective or objective datum associated with the intellectual domain 236. Schedule components or events that may be added to exploit value in intellectual domain 236 include events determined to maximize intellectual fulfilment, including enrolling in educational programs, enjoying cultural events, and the like.

With continued reference to FIG. 2, at least a domain may include lifestyle domain 240. Objective data that may be associated with lifestyle domain includes amount of time spent in ideal or unideal lifestyle settings. Subjective data may include a rating of system's level of lifestyle fulfilment. A domain target associated with lifestyle domain 240 may include a change in a subjective or objective datum associated with the lifestyle domain 240. Schedule components or events that may be added to exploit value in lifestyle domain 240 include events determined to maximize lifestyle fulfilment, including housing, travel, wardrobe, toys, activities, systems and free time.

With continued reference to FIG. 2, at least a domain may include interest domain 244. Objective data that may be associated with interest domain includes amount of time on avocational pursuits or personally enjoyable activities. Subjective data may include a rating of system's level of interest fulfilment. A domain target associated with interest domain 244 may include a change in a subjective or objective datum associated with the interest domain 244. Schedule components or events that may be added to exploit value in interest domain 244 include events determined to maximize interest fulfilment, including hobbyist events, and the like.

With continued reference to FIG. 2, at least a domain may include social domain 248. Objective data that may be associated with social domain includes amount of time spent with others in a social setting, for example time spent enjoying one another. Subjective data may include a rating of system's level of social fulfilment. A domain target associated with social domain 248 may include a change in a subjective or objective datum associated with the social domain 248. Schedule components or events that may be added to exploit value in social domain 248 include events determined to maximize social fulfilment, including participating in social events, engaging with a club, friends, systems, entertainment events, and the like.

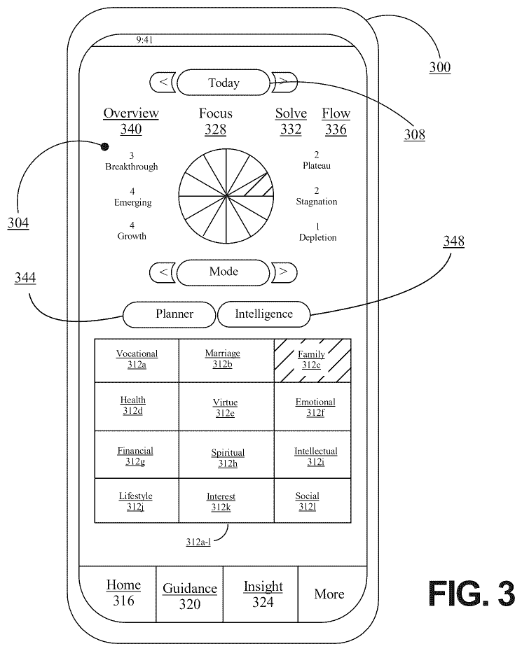

Referring now to FIG. 3, an exemplary embodiment of a remote device 300 is illustrated. In some cases, remote device 300 may interface with user by way of a graphical user interface (GUI) 304. In some cases, remote device 300 may display to user a schedule 308, such as without limitation a weekly schedule. In some cases, schedule 308 function allows a user to view and edit a user schedule. In some embodiments, schedule 308 may be an optimal user schedule generated using a computing device. In some cases, remote device 300 may display to user domains 312a-1. In some cases, progress (e.g., evaluation results) related to a domain may be represented by GUI, such as by way of color coding. For example, family domain 312c is indicated with hashmarks to indicate that family is an undesirable (e.g., depleted) status. In some cases, a status for each domain may be indicated to user by way of GUI 304, for example in a “Home” view 316. In some cases, GUI may allow user access to resources. In some cases, resources may be domain specific. Exemplary resources include guidance 320 and insight 324. Guidance 320 may include any audio information designed to enrich a user, for example within a specific domain. Insight 324 may include any media, such as video, text, and the like intended to enrich a user, for example within a specific domain. Focus 328 may isolate one or more domains that may aid in a more focused and concentrated experience to assist in driving change and progress. Solve 332 may include a scheduled focus for a particular period of time such as a day, week, month, quarter, year, and the like. Solve 332 may display information pertaining to particular issues and problems to solve and may aid in selecting one or more breakthrough domains. Flow 336 may include habits, projects, rocks and to-dos that may be aligned with a user's priorities and interests. Overview 340 may include a big picture view of domains, realms, and/or categories. Planner 344 and/or intelligence 348 may include one or more digital copies of handwritten tools that may be integrated and automatically updated and available within graphical user interface 304.

In some embodiments, GUI 304 may enable a user to interact with specific resources of a domain. For example, when a user interacts with home 316, GUI 304 may illuminate domains 312a-l with different colors based at least on a status of each domain. Additionally, one or more domains may be considered as an undesirable status (e.g., depleted). As described in the above example, FIG. 3 illustrates family domain 312c being depleted. In some embodiments, display box for family domain 312c may be pulsating. That is, display box for family domain 312c may appear to rise and fall into the plane of GUI 304. This may draw a user's attention to family domain 312c. The pulsating feature may be especially beneficial for users with sight problems such as color blindness. In some embodiments, display box for family domain 312c may be interacted with and maximized to a full screen mode. While in full screen, a plurality of lessons and their respective completion statuses may be displayed. It should be noted that the full screen capability may be available upon interacting with any domain display box and is not limited to undesirable status domains. In some embodiments, full screen mode may be an automatic response to a user interacting with home 316. For example, a user may interact with home 316 and in response to the user's interaction, a full screen mode of one or more undesirable status domains, with their respective plurality of lessons and completion statuses, will be displayed.

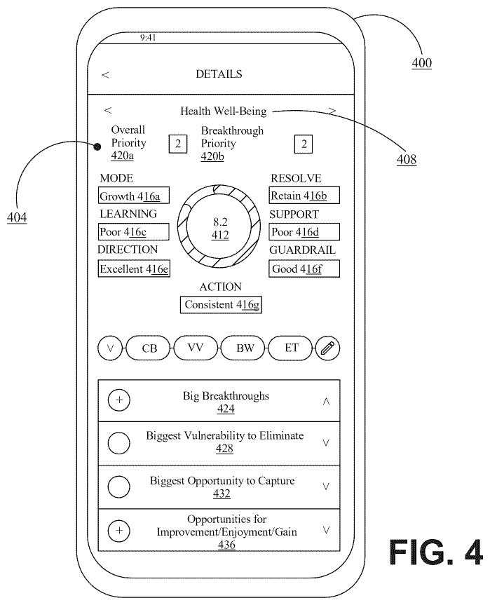

Referring now to FIG. 4, an exemplary remote device 400 is illustrated. In some cases, remote device 400 may interface with system by way of a graphical user interface (GUI) 404. In some cases, remote device 400 may display domain-specific information 408, for instance information related to health domain. In some cases, an overall domain-specific rating 412 (i.e., evaluation result) may be presented to system. Additionally, subordinate domain-specific ratings (i.e., evaluation results) 416a-g may be presented to system. For example, subordinate domain-specific ratings may be related to mode 416a, resolve 416b, learning 416c, support 416d, direction 416e, guardrail 416f, action 416g, and the like. In some cases, a domain may be prioritized, for example with an overall priority 420a and/or a breakthrough priority 420b. In some cases, domain-specific information may be enumerated and/or prioritized. Exemplary enumerations and/or prioritizations include without limitation big breakthroughs 424, biggest vulnerability to eliminate 428, biggest opportunity to capture 432, opportunities for improvement/enjoyment/gain 436, and the like.

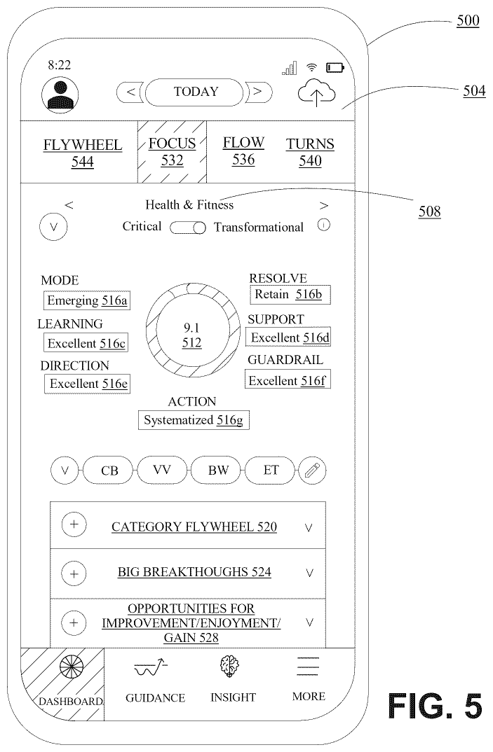

Referring now to FIG. 5, an exemplary remote device 500 including an exemplary graphical user interface 504 of a remote device illustrating the focus tab of the dashboard screen of a user with an excellent performance level on a given day. In some cases, remote device 500 may interface with system by way of a graphical user interface (GUI) 504. In some cases, remote device 500 may display domain-specific information 508, for instance information related to the health and fitness domain. In some cases, an overall domain-specific rating 512 (i.e., evaluation result) may be presented to system. Additionally, subordinate domain-specific ratings (i.e., evaluation results) 516a-g may be presented to system. For example, subordinate domain-specific ratings may be related to mode 516a, resolve 516b, learning 516c, support 516d, direction 516e, guardrail 516f, action 516g, and the like. In some cases, domain-specific information may be enumerated and/or prioritized. Exemplary enumerations and/or prioritizations include without limitation category flywheel 520, big breakthroughs 524, opportunities for improvement/enjoyment/gain 528, and the like. In some cases, focus 532 may isolate one or more domains that may aid in a more focused and concentrated experience to assist in driving change and progress. In some cases, flow 536 may include habits, projects, rocks and to-dos that may be aligned with a user's priorities and interests. In some cases, turns 540 may include information related to key turns over different time periods. In some cases, flywheel 544 may include a big picture view of domains, realms, and/or categories.

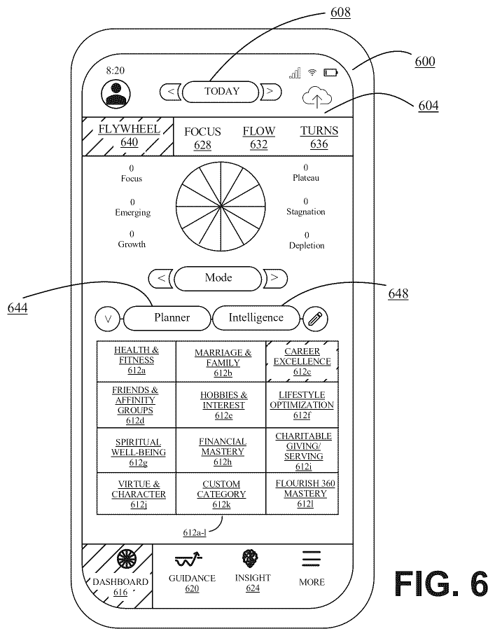

Referring now to FIG. 6, an exemplary remote device 600 including an exemplary graphical user interface 604 of a remote device illustrating the flywheel tab of the dashboard screen with exemplary domains. In some cases, remote device 600 may interface with user by way of a graphical user interface (GUI) 604. In some cases, remote device 600 may display to user a schedule 608, such as without limitation a weekly schedule. In some cases, schedule 608 function allows a user to view and edit a user schedule. In some embodiments, schedule 608 may be an optimal user schedule generated using a computing device. In some cases, remote device 600 may display to user domains 612a-1. In some cases, progress (e.g., evaluation results) related to a domain may be represented by GUI, such as by way of color coding. For example, career excellence domain 612c is indicated with hashmarks to indicate that career excellence is an undesirable (e.g., depleted) status. In some cases, a status for each domain may be indicated to user by way of GUI 604, for example in dashboard view 616. In some cases, GUI may allow user access to resources. In some cases, resources may be domain specific. Exemplary resources include guidance 620 and insight 624. Guidance 620 may include any audio information designed to enrich a user, for example within a specific domain. Insight 624 may include any media, such as video, text, and the like intended to enrich a user, for example within a specific domain. Focus 628 may isolate one or more domains that may aid in a more focused and concentrated experience to assist in driving change and progress. Flow 632 may include habits, projects, rocks and to-dos that may be aligned with a user's priorities and interests. Turns 636 may include information related to key turns over different time periods. Flywheel 640 may include a big picture view of domains, realms, and/or categories. Planner 644 and/or intelligence 648 may include one or more digital copies of handwritten tools that may be integrated and automatically updated and available within graphical user interface 604.

In some embodiments, GUI 604 may enable a user to interact with specific resources of a domain. For example, when a user interacts with dashboard 616, GUI 604 may illuminate domains 612a-l with different colors based at least on a status of each domain. Additionally, one or more domains may be considered as an undesirable status (e.g., depleted). As described in the above example, FIG. 3 illustrates family domain 312c being depleted. In some embodiments, display box for career excellence 612c may be pulsating. That is, display box for career excellence 612c may appear to rise and fall into the plane of GUI 604. This may draw a user's attention to career excellence 612c. The pulsating feature may be especially beneficial for users with sight problems such as color blindness. In some embodiments, display box for career excellence domain 612c may be interacted with and maximized to a full screen mode. While in full screen, a plurality of lessons and their respective completion statuses may be displayed. It should be noted that the full screen capability may be available upon interacting with any domain display box and is not limited to undesirable status domains. In some embodiments, full screen mode may be an automatic response to a user interacting with dashboard 616. For example, a user may interact with dashboard 616 and in response to the user's interaction, a full screen mode of one or more undesirable status domains, with their respective plurality of lessons and completion statuses, will be displayed.

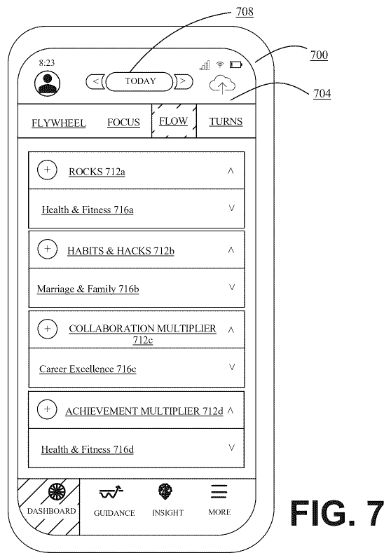

Referring now to FIG. 7, an exemplary remote device 700 including an exemplary graphical user interface 704 of a remote device. In some cases, remote device 700 may interface with user by way of a graphical user interface (GUI) 704. In some cases, remote device 700 may display to user a schedule 708, such as without limitation a weekly schedule. In some cases, schedule 708 function allows a user to view and edit a user schedule. In some embodiments, schedule 708 may be an optimal user schedule generated using a computing device.

With continued reference to FIG. 7, remote device 700 may display suggestions 712a-d such as “Rocks” 712a, “Habits & Hacks” 712b, “Collaboration Multiplier” 712c, “Achievement Multiplier” 712d, and the like. Each suggestion category may include at least a domain with a respective drop-down menu option 716a-d. In some instances, at least a domain may be color coded to indicate a domain-specific rating. As a non-limiting example, at least a domain may be a green shade if a respective domain-specific rating is above a certain threshold (e.g., 7.1). Further, at least a domain may be a yellow shade if a respective domain-specific rating is below a certain threshold (e.g., 7.0). In some cases, at least a domain drop-down menu 716a-d may include one or more recommendations and/or one or more suggestions associated with the suggestion category and the at least a domain. As a non-limiting example, a drop-down option for “Habits & Hacks” 712b may include “Marriage & Family” 716b which may include habits and/or productivity hacks to improve a user's marriage and family relationships. Continuing the non-limiting example, “Habits & Hacks” 712b that improve the user's marriage and family relationships may include date night suggestions, suggested modification to hours, prioritizing the user's work tasks based on predetermined importance, and the like.

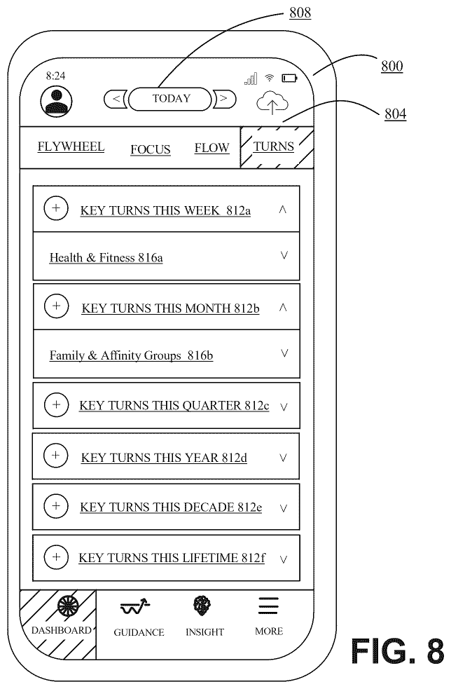

Referring now to FIG. 8, an exemplary remote device 800 including an exemplary graphical user interface 804 of a remote device. In some cases, remote device 800 may interface with user by way of a graphical user interface (GUI) 804. In some cases, remote device 800 may display to user a schedule 808, such as without limitation a weekly schedule. In some cases, schedule 808 function allows a user to view and edit a user schedule. In some embodiments, schedule 808 may be an optimal user schedule generated using a computing device. In some cases, remote device 800 may display key turns 812a-d such as “Key Turns This Week” 812a, “Key Turns This Month” 812b, “Key Turns This Quarter” 812c, “Key Turns This Year” 812d, “Key Turns This Decade” 812e, “Key Turns This Lifetime” 812f, and the like. Each suggestion category may include at least a domain with a respective drop-down menu option 816a-b. In some instances, at least a domain may be color coded to indicate a domain-specific rating. As a non-limiting example, at least a domain may be a green shade if a respective domain-specific rating is above a certain threshold (e.g., 7.1). Further, at least a domain may be a yellow shade if a respective domain-specific rating is below a certain threshold (e.g., 7.0). In some cases, at least a domain drop-down menu 816a-b may include one or more recommendations and/or one or more suggestions associated with the suggestion category and the at least a domain. As a non-limiting example, a drop-down option for “Key Turns This Week” 812a may include “Health & Fitness” 816a which may include key turns regarding the upcoming week to improve a user's health and fitness goals.

Referring now to FIG. 9, an exemplary embodiment of a machine-learning module 900 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 904 to generate an algorithm instantiated in hardware or software logic, data structures, and/or functions that will be performed by a computing device/module to produce outputs 908 given data provided as inputs 912; this is in contrast to a non-machine learning software program where the commands to be executed are determined in advance by a user and written in a programming language.

Still referring to FIG. 9, “training data,” as used herein, is data containing correlations that a machine-learning process may use to model relationships between two or more categories of data elements. For instance, and without limitation, training data 904 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 904 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 904 according to various correlations; correlations may indicate causative and/or predictive links between categories of data elements, which may be modeled as relationships such as mathematical relationships by machine-learning processes as described in further detail below. Training data 904 may be formatted and/or organized by categories of data elements, for instance by associating data elements with one or more descriptors corresponding to categories of data elements. As a non-limiting example, training data 904 may include data entered in standardized forms by persons or processes, such that entry of a given data element in a given field in a form may be mapped to one or more descriptors of categories. Elements in training data 904 may be linked to descriptors of categories by tags, tokens, or other data elements; for instance, and without limitation, training data 904 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 9, training data 904 may include one or more elements that are not categorized; that is, training data 904 may not be formatted or contain descriptors for some elements of data. Machine-learning algorithms and/or other processes may sort training data 904 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 904 to be made applicable for two or more distinct machine-learning algorithms as described in further detail below. Training data 904 used by machine-learning module 900 may correlate any input data as described in this disclosure to any output data as described in this disclosure. As a non-limiting illustrative example plurality of evaluation metrics which may include questionnaires, surveys, and other qualitative metrics to evaluate the system, and/or first dataset.

Further referring to FIG. 9, training data may be filtered, sorted, and/or selected using one or more supervised and/or unsupervised machine-learning processes and/or models as described in further detail below; such models may include without limitation a training data classifier 916. Training data classifier 916 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 900 may generate a classifier using a classification algorithm, defined as a processes whereby a computing device and/or any module and/or component operating thereon derives a classifier from training data 904. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 916 may classify elements of training data to executive function, emotional regulation, and the like.

Still referring to FIG. 9, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 9, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 9, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 9, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 9, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 9, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 9, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 9, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 9, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 9, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 9, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 9, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 9, machine-learning module 900 may be configured to perform a lazy-learning process 920 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 904. Heuristic may include selecting some number of highest-ranking associations and/or training data 904 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 9, machine-learning processes as described in this disclosure may be used to generate machine-learning models 924. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 924 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 924 may be generated by creating an artificial neural network, such as a convolutional neural network comprising an input layer of nodes, one or more intermediate layers, and an output layer of nodes. Connections between nodes may be created via the process of “training” the network, in which elements from a training data 904 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 9, machine-learning algorithms may include at least a supervised machine-learning process 928. At least a supervised machine-learning process 928, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include representation data as described above as inputs, first dataset as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 904. Persons skilled in the art, upon reviewing the entirety of this disclosure, will be aware of various possible variations of at least a supervised machine-learning process 928 that may be used to determine relation between inputs and outputs. Supervised machine-learning processes may include classification algorithms as defined above.

With further reference to FIG. 9, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 9, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 9, machine learning processes may include at least an unsupervised machine-learning processes 932. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 932 may not require a response variable; unsupervised processes 932 may be used to find interesting patterns and/or inferences between variables, to determine a degree of correlation between two or more variables, or the like.

Still referring to FIG. 9, machine-learning module 900 may be designed and configured to create a machine-learning model 924 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 9, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 9, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 9, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 9, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 9, one or more processes or algorithms described above may be performed by at least a dedicated hardware unit 936. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 936 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 936 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 936 to perform one or more operations described herein, such as evaluation of model and/or algorithm outputs, one-time or iterative updates to parameters, coefficients, weights, and/or biases, and/or any other operations such as vector and/or matrix operations as described in this disclosure.

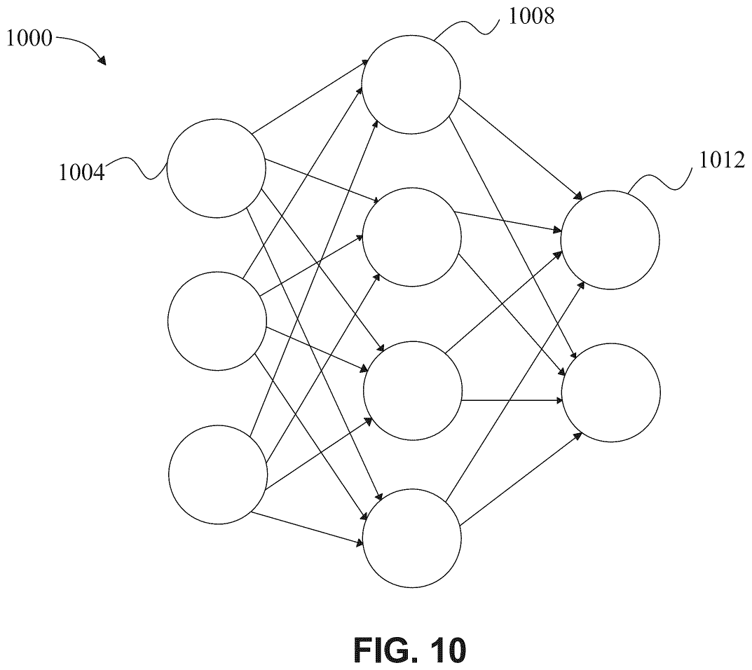

Referring now to FIG. 10, an exemplary embodiment of neural network 1000 is illustrated. A neural network 1000 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1004, one or more intermediate layers 1008, and an output layer of nodes 1012. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

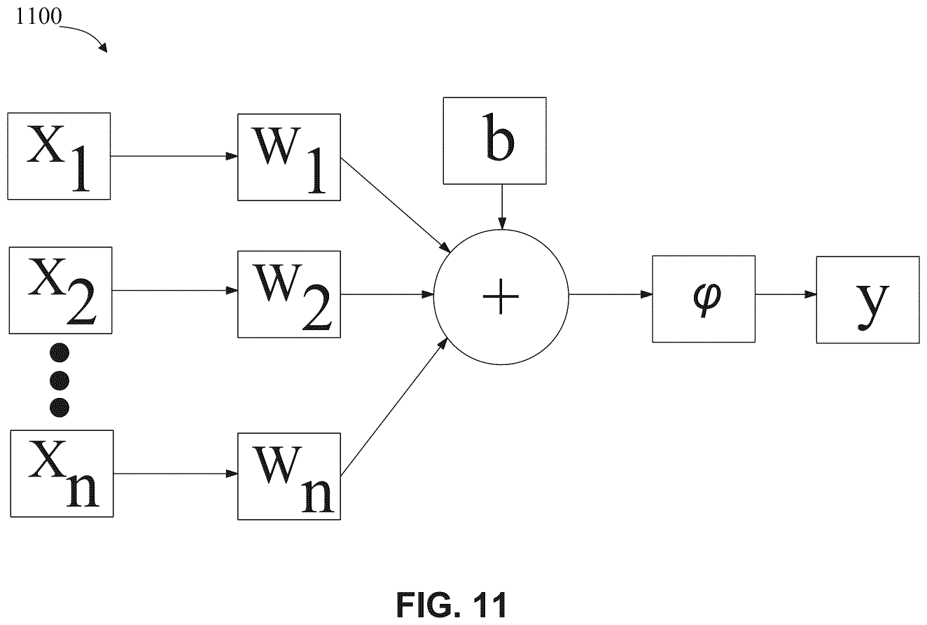

Referring now to FIG. 11, an exemplary embodiment of a node 1100 of a neural network is illustrated. A node may include, without limitation, a plurality of inputs x, that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs x, that may be used as activation functions. As a non-limiting and illustrative example, node may perform a weighted sum of inputs using weights w, that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

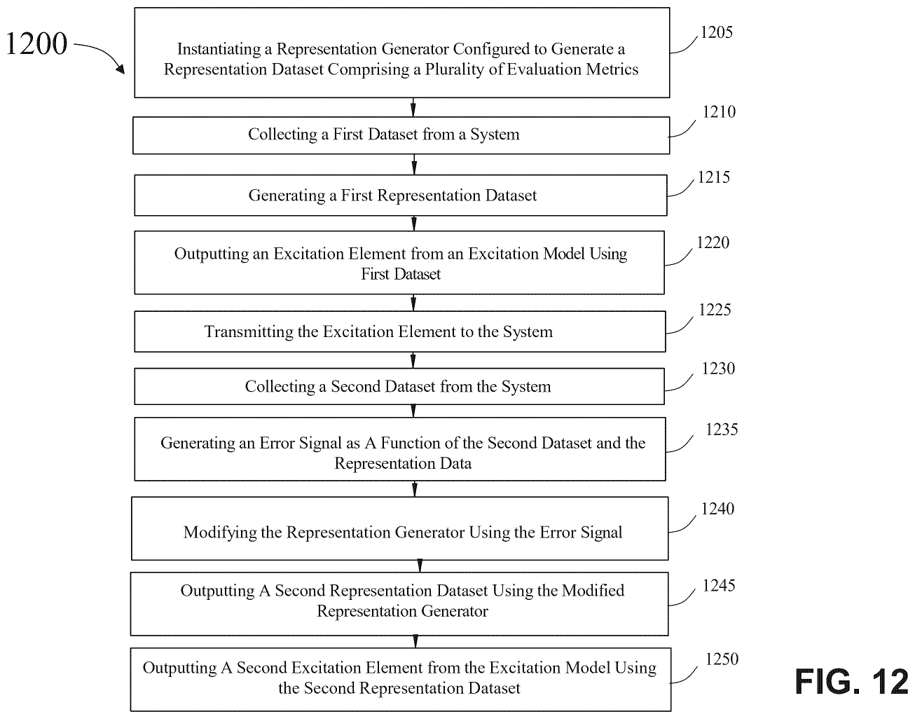

Referring now to FIG. 12, a flow diagram of an exemplary method 1200 for training an excitation model using representation data is illustrated. At step 1205, method 1200 includes instantiating, using at least a processor, a representation generator, wherein the representation generator is configured to generate a representation dataset, wherein the representation dataset comprises a plurality of evaluation metrics. This may be implemented as described and with reference to FIGS. 1-11.

Still referring to FIG. 12, at step 1210, method 1200 includes collecting, using at least a processor, a first dataset from a system, wherein the representation dataset is transmitted to the system and a response is recorded from the system. This may be implemented as described and with reference to FIGS. 1-11.

Still referring to FIG. 12, at step 1215, method 1200 includes generating, using the representation generator and the first dataset, a first representation data. This may be implemented as described and with reference to FIGS. 1-11.

Still referring to FIG. 12, at step 1220, method 1200 includes outputting, using at least a processor, an excitation element from an excitation model using first dataset. This may be implemented as described and with reference to FIGS. 1-11.

Still referring to FIG. 12, at step 1225, method 1200 includes transmitting, using at least a processor, the excitation element to the system. This may be implemented as described and with reference to FIGS. 1-11.

Still referring to FIG. 12, at step 1230, method 1200 includes collecting, using at least a processor, a second dataset from the system. This may be implemented as described and with reference to FIGS. 1-11.

Still referring to FIG. 12, at step 1235, method 1200 includes generating, using at least a processor, an error signal as a function of the second dataset and the representation data. This may be implemented as described and with reference to FIGS. 1-11.

Still referring to FIG. 12, at step 1240, method 1200 includes modifying, using at least a processor, the representation generator using the error signal, wherein modifying the representation generator is configured to generate at least a modified evaluation metric. This may be implemented as described and with reference to FIGS. 1-11.

Still referring to FIG. 12, at step 1245, method 1200 includes outputting, using at least a processor, a second representation dataset using the modified representation generator. This may be implemented as described and with reference to FIGS. 1-11.

Still referring to FIG. 12, at step 1250, method 1200 includes outputting, using at least a display device, a second excitation element from the excitation model using the second representation dataset. This may be implemented as described and with reference to FIGS. 1-11.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

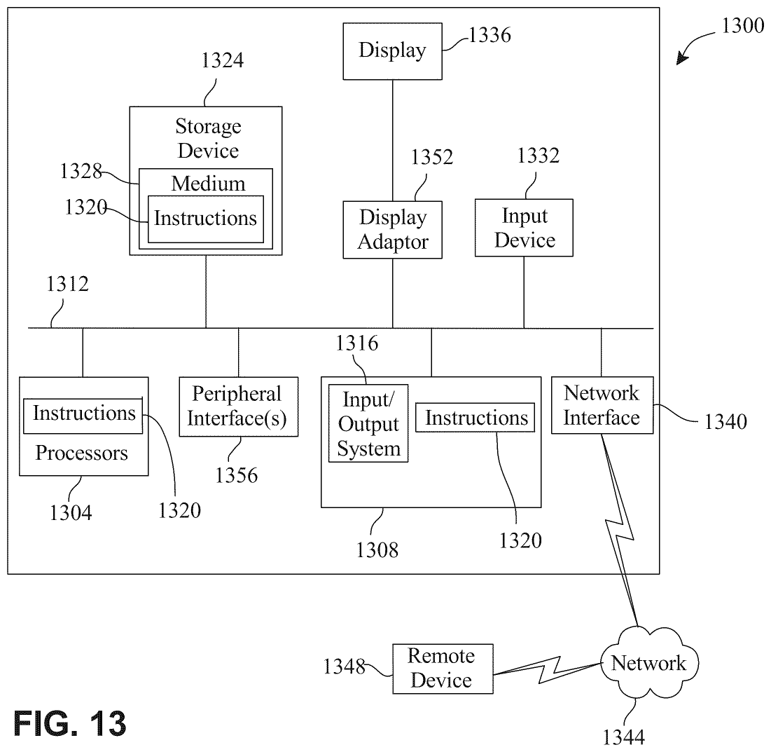

FIG. 13 shows a diagrammatic representation of one embodiment of computing device in the exemplary form of a computer system 1300 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1300 includes a processor 1304 and a memory 1308 that communicate with each other, and with other components, via a bus 1312. Bus 1312 may include any of several types of bus structures including, but not limited to, a memory bus, a memory controller, a peripheral bus, a local bus, and any combinations thereof, using any of a variety of bus architectures.

Processor 1304 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1304 may be organized according to Von Neumann and/or Harvard architecture as a non-limiting example. Processor 1304 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1308 may include various components (e.g., machine-readable media) including, but not limited to, a random-access memory component, a read only component, and any combinations thereof. In one example, a basic input/output system 1316 (BIOS), including basic routines that help to transfer information between elements within computer system 1300, such as during start-up, may be stored in memory 1308. Memory 1308 may also include (e.g., stored on one or more machine-readable media) instructions (e.g., software) 1320 embodying any one or more of the aspects and/or methodologies of the present disclosure. In another example, memory 1308 may further include any number of program modules including, but not limited to, an operating system, one or more application programs, other program modules, program data, and any combinations thereof.

Computer system 1300 may also include a storage device 1324. Examples of a storage device (e.g., storage device 1324) include, but are not limited to, a hard disk drive, a magnetic disk drive, an optical disc drive in combination with an optical medium, a solid-state memory device, and any combinations thereof. Storage device 1324 may be connected to bus 1312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1324 (or one or more components thereof) may be removably interfaced with computer system 1300 (e.g., via an external port connector (not shown)). Particularly, storage device 1324 and an associated machine-readable medium 1328 may provide nonvolatile and/or volatile storage of machine-readable instructions, data structures, program modules, and/or other data for computer system 1300. In one example, software 1320 may reside, completely or partially, within machine-readable medium 1328. In another example, software 1320 may reside, completely or partially, within processor 1304.

Computer system 1300 may also include an input device 1332. In one example, a user of computer system 1300 may enter commands and/or other information into computer system 1300 via input device 1332. Examples of an input device 1332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1332 may be interfaced to bus 1312 via any of a variety of interfaces (not shown) including, but not limited to, a serial interface, a parallel interface, a game port, a USB interface, a FIREWIRE interface, a direct interface to bus 1312, and any combinations thereof. Input device 1332 may include a touch screen interface that may be a part of or separate from display 1336, discussed further below. Input device 1332 may be utilized as a user selection device for selecting one or more graphical representations in a graphical interface as described above.

A user may also input commands and/or other information to computer system 1300 via storage device 1324 (e.g., a removable disk drive, a flash drive, etc.) and/or network interface device 1340. A network interface device, such as network interface device 1340, may be utilized for connecting computer system 1300 to one or more of a variety of networks, such as network 1344, and one or more remote devices 1348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1344, may employ a wired and/or a wireless mode of communication. In general, any network topology may be used. Information (e.g., data, software 1320, etc.) may be communicated to and/or from computer system 1300 via network interface device 1340.

Computer system 1300 may further include a video display adapter 1352 for communicating a displayable image to a display device, such as display 1336. Examples of a display device include, but are not limited to, a liquid crystal display (LCD), a cathode ray tube (CRT), a plasma display, a light emitting diode (LED) display, and any combinations thereof. Display adapter 1352 and display 1336 may be utilized in combination with processor 1304 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1312 via a peripheral interface 1356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for training an excitation model, wherein the apparatus comprises:
at least a processor; and
a memory communicatively connected to the at least a processor, wherein the memory contains instructions configuring the at least a processor to:
instantiate a representation generator;
collect a first dataset from a system;
generate, using the representation generator and the first dataset, a first representation dataset, wherein the first representation dataset comprises a plurality of evaluation metrics;
output one or more excitation elements from the excitation model using the first representation dataset, wherein an excitation element comprises a system recommendation coming a neurocognitive exercise to increase performance in a cognitive or behavioral domain;
transmit the excitation element to the system;
collect a second dataset from the system;
generate an error signal as a function of the second dataset and the first representation dataset;
tune the representation generator iteratively using the error signal to correct a deficiency of the system;
modify the representation generator using the error signal, wherein modifying the representation generator is configured to generate at least a modified evaluation metric comprising a reprioritization of the one or more excitation elements;
output a second representation dataset using the modified representation generator; and
output a second excitation element from the excitation model using the second representation dataset.

2. The apparatus of claim 1, wherein the representation generator comprises a machine learning model.

3. The apparatus of claim 2, wherein the machine learning model is configured to:
identify a focus area for the system to optimize;
prioritize the focus area; and
generate the representation dataset that further examines the focus area.

4. The apparatus of claim 2, wherein the machine learning model is iteratively trained on a plurality of datasets as a function of the representation dataset.

5. The apparatus of claim 1, wherein collecting the first dataset comprises receiving information from a generative data model.

6. The apparatus of claim 1, wherein the excitation model comprises a large language model.

7. The apparatus of claim 6, wherein the large language model comprises a generative pretrained transformer.

8. The apparatus of claim 1, wherein the excitation model further comprises a neural network.

9. The apparatus of claim 1, wherein the excitation element is presented to the system through a graphical user interface, wherein the graphical user interface is configured to display a data structure to the system using a display device.

10. The apparatus of claim 9, wherein the graphical user interface comprises a plurality of visual elements associated with a plurality of event handlers.

11. A method for training an excitation model, wherein the method comprises:
instantiating a representation generator;
collecting a first dataset from a system;
generating, using the representation generator and the first dataset, a first representation dataset, wherein the first representation dataset comprises a plurality of evaluation metrics;
outputting one or more excitation elements from the excitation model using the first representation dataset, wherein an excitation element comprises a system recommendation coming a neurocognitive exercise to increase performance in a cognitive or behavioral domain;
transmitting the excitation element to the system;
collecting a second dataset from the system;
generating an error signal as a function of the second dataset and the representation dataset;
tune the representation generator iteratively using the error signal to correct a deficiency of the system;
modifying the representation generator using the error signal, wherein modifying the representation generator is configured to generate at least a modified evaluation metric comprising a reprioritization of the one or more excitation elements;
outputting a second representation dataset using the modified representation generator; and
outputting a second excitation element from the excitation model using the second representation dataset.

12. The method of claim 11, wherein the representation generator comprises a machine learning model.

13. The method of claim 12, wherein the machine learning model is configured to:
identify a focus area for the system to optimize;
prioritize the focus area; and
generate the representation dataset that further examines the focus area.

14. The method of claim 12, wherein the machine learning model is iteratively trained on a plurality of datasets as a function of the representation dataset.

15. The method of claim 11, wherein collecting the first dataset comprises receiving information from a generative data model.

16. The method of claim 11, wherein the excitation model comprises a large language model.

17. The method of claim 16, wherein the large language model comprises a generative pretrained transformer.

18. The method of claim 11, wherein the excitation model further comprises a neural network.

19. The method of claim 11, wherein the excitation element is presented to the system through a graphical user interface, wherein the graphical user interface is configured to display a data structure to the system using a display device.

20. The method of claim 19, wherein the graphical user interface comprises a plurality of visual elements associated with a plurality of event handlers.
